(19) United States
(12) Patent Application Publication
(10) Pub. No.: US 2014/0299265 A1
(43) Pub. Date: Oct. 9, 2014

(54) DRY APPLY AND/OR PEEL AWAY TEMPORARY BODY DECALS

(71) Applicant: Global Sport Products LLC, Tyler, TX (US)

(72) Inventor: Douglas Marshall, Tyler, TX (US)

(21) Appl. No.: 14/244,202

(22) Filed: Apr. 3, 2014

Related U.S. Application Data
(60) Provisional application No. 61/808,204, filed on Apr. 3, 2013.

(51) Int. Cl. B44C 1/16; B44C 1/17; B44C 1/10

(52) U.S. Cl. CPC B44C 1/16; B44C 1/105; B44C 1/1741
USPC 156/249; 428/42.1; 428/41.1

(57) ABSTRACT

Dry apply and/or peel away temporary body decals may be comprised of a decal applied to a backing with an adhesive associated with the decal. A protective laminate may be applied to protect the decal until it is used. The user may apply the decal to his/her body, and the decal may be applied without the use of water. When the user is ready to remove the temporary body decal, the adhesive associated with the decal may provide a means for the user to detach the temporary body decal from his/her body without leaving a residue on his/her body and without the need to use soap and water to remove the temporary body decal.

### CROSS REFERENCE TO RELATED APPLICATION

This application claims the benefit of U.S. Provisional Application No. 61/808,204 filed Apr. 3, 2013, entitled “Peel Away Temporary Transfers” which is incorporated herein by reference in its entirety.

### FIELD OF THE DISCLOSURE

The present disclosure generally relates to temporary body decals, and more particularly to dry apply and/pr peel away temporary body decals.

### BACKGROUND

While temporary transfers, such as tattoos, have previously been available, they tend to be somewhat difficult to remove. For example, a person may apply a temporary tattoo to show support for his/her team at a live sporting event. In some instances, the person must have access to water in order to apply the temporary tattoo. Then, the person may not wish to keep the temporary tattoo applied at the conclusion of the event, for example, if he/she may be going to dinner afterwards. In order to remove the temporary tattoo, soap and water may be needed but may not be readily accessible. In other instances, depending on the strength of the application, the temporary tattoo may still not easily or completely wash away using soap and water. As such, the person may be forced to continue wearing the temporary tattoo, in whole or in part, sometimes long after the event with which the temporary tattoo was attached has concluded.

### SUMMARY

Embodiments of the present disclosure may provide a method for applying a temporary body decal to a user's face, the method comprising peeling away a backing associated with the temporary body decal, the temporary body decal including a decal, an adhesive on one side of the decal, and the backing, centering the temporary body decal on the user's nose with the adhesive of the temporary body decal facing the user's skin, and pressing the temporary body decal onto the user's face with eyeholes of the temporary body decal in the area of the user's eyes. The pressing step may further comprise pressing onto the user's face from the nose portion outward, and securing loose areas of the temporary body decal. Before the temporary body decal is centered on the user's name, the area of the user's face where the temporary body decal is to be applied may be washed and dried. The method may further comprise removing the temporary body decal by the following steps: identifying a loose edge of the temporary body decal, lifting the loose edge of the temporary body decal, stretching the temporary body decal, and peeling the temporary body decal from the user's face. The removing step may be performed without the use of a wetting mechanism. The centering and pressing steps may be performed without the use of a wetting mechanism. The decal may be selected from the group comprising single colors, color combinations, sports logos or designs, costume masks, camouflage, patriotic designs, paint-your-own, promotions for a company or cause, and combinations thereof.

Embodiments of the present disclosure also may provide a dry apply temporary body decal comprising a decal, an adhesive applied to the decal that transfers the decal to a user's body, and a backing that is releasably detachable from the decal, wherein the decal is transferred to a user's body without the use of a wetting mechanism. The backing may be a single piece of material or may be formed as more than one piece of material. The adhesive may enable removal of the decal from the user's body. The adhesive may comprise an aqueous blend of styrene-acrylic polymers having a glass transition temperature of +10° C. to +40° C. and acrylate co-polymers having a glass transition temperature of −25° C. to −55° C. comprising 60-90 parts of the adhesive, and an aqueous mixture of inert attapulgite and calcium carbonate comprising 10-30 parts of the adhesive. The adhesive may further comprise additives for coating rheology comprising 10 parts or less of the adhesive. The decal may be selected from the group comprising single colors, color combinations, sports logos or designs, costume masks, camouflage, patriotic designs, paint-your-own, promotions for a company or cause, and combinations thereof. The decal may be removed from the user's body without use of a wetting mechanism.

Other embodiments of the present disclosure may provide a peel away temporary body decal comprising a decal, an adhesive applied to the decal that transfers the decal to a user's body and enables removal of the decal from the user's body, and a backing that is releasably detachable from the decal, wherein removal of the decal occurs without use of a wetting mechanism. The adhesive may have a viscosity in the range of approximately 14,000 to 25,000 cps or in the range of approximately 16,200 to 22,000 cps. The decal may be selected from the group comprising single colors, color combinations, sports logos or designs, costume masks, camouflage, patriotic designs, paint-your-own, promotions for a company or cause, and combinations thereof. The decal may be transferred to a user's body without use of a wetting mechanism.

### BRIEF DESCRIPTION OF THE DRAWINGS

For a more complete understanding of this disclosure, reference is now made to the following description, taken in conjunction with the accompanying drawings, in which:

FIG. 1 depicts a dry apply and/or peel away temporary body decal system according to an embodiment of the present disclosure;

FIGS. 2A-2F depicts color-related dry apply and/or peel away temporary body decal according to embodiments of the present disclosure;

FIGS. 3A-3D depict costume-related dry apply and/or peel away temporary body decal according to embodiments of the present disclosure;

FIG. 4 depicts a camouflage dry apply and/or peel away temporary body decal according to an embodiment of the present disclosure;

FIGS. 5A-5B depicts girl-focused dry apply and/or peel away temporary body decal according to embodiments of the present disclosure;

FIG. 6 depicts a tear and share dry apply and/or peel away temporary body decal according to an embodiment of the present disclosure;

FIG. 7 depicts a party-related dry apply and/or peel away temporary body decal according to an embodiment of the present disclosure;

FIGS. 8A-8C depict flag-related dry apply and/or peel away temporary body decals according to embodiments of the present disclosure;

FIG. 9 depicts a paint-your-own dry apply and/or peel away temporary body decal according to an embodiment of the present disclosure;

FIG. 10 depicts a method for apply a jewel-type dry apply and/or peel away temporary body decal according to an embodiment of the present disclosure; and

FIG. 11 depicts a method to apply a dry apply and/or peel away temporary body decal according to an embodiment of the present disclosure.

### DETAILED DESCRIPTION

Embodiments of the present disclosure may provide for dry apply and/or peel away temporary body decals that may be applied to all or a portion of a user's face or another portion of his/her body and then removed without the need for soap and water. In some embodiments of the present disclosure, the temporary body decal may be applied to a user's body without the need for water or other wetting mechanism. Further, dry apply and/or peel away temporary body decals according to embodiments of the present disclosure may be removed as a single piece and will not leave residue or portions of the temporary body decal on the user's body when it is removed. In addition, dry apply and/or peel away temporary body decals may be removed without the need for water or other wetting mechanism.

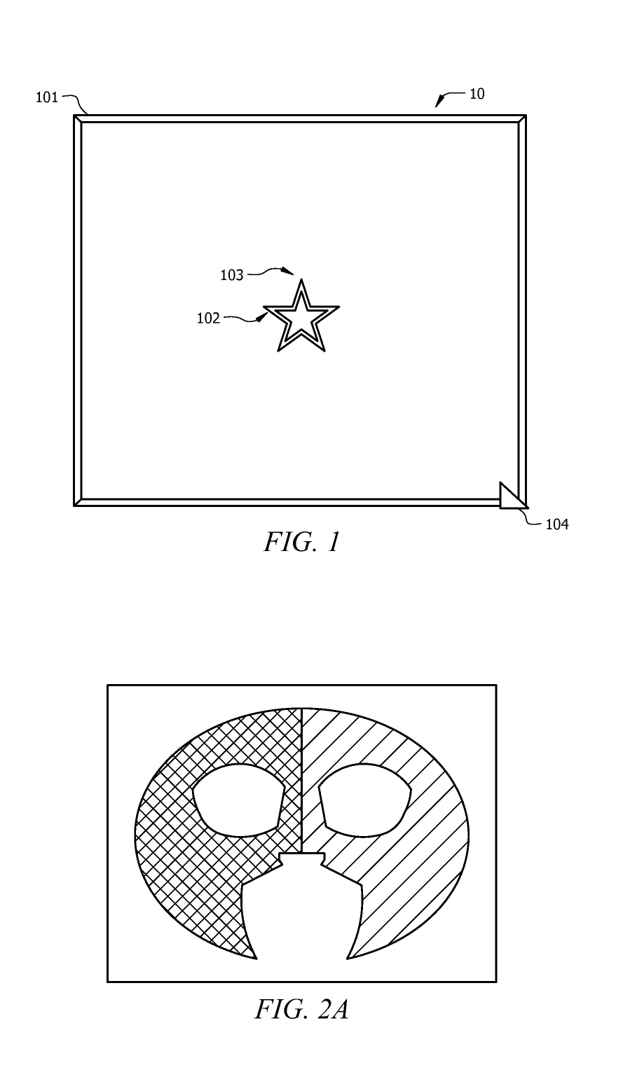

Dry apply and/or peel away temporary body decals according to embodiments of the present disclosure may be provided having several parts. FIG. 1 depicts temporary body decal system 10 according to an embodiment of the present disclosure. System 10 may include backing 101 that may be a paper material or other similar type of material that may be configured to receive decal 102. It should be appreciated that backing 101 may be provided as a single piece of material that may be separated from decal 102 according to some embodiments of the present disclosure. However, there may be other embodiments of the present disclosure wherein backing 101 may be affixed to decal 102 in more than one piece so that each piece may be selectively detached from decal 102 for ease in application to a user's body. In an embodiment of the present disclosure, backing 101 may include a first portion that may be associated with the portion of decal 102 that may be affixed to a user's nose while a second and a third portion may be associated with portions of decal 102 that may be affixed around each of the user's eyes. However, it should be appreciated that backing 101 may be formed of more or fewer than three portions without departing from the present disclosure.

Adhesive 103 may be applied to or associated with decal 102 so that when decal 102 is applied to a user's body, adhesive 103 may allow decal 102 to be transferred to the user's body, such as the user's face or another body part, while providing a means for the user to more easily remove decal 102 from his/her body when desired. Use of adhesive 103 may enable a user to easily apply and remove the temporary body decal at his/her election according to embodiments of the present disclosure.

It should be appreciated that adhesive 103 according to embodiments of the present disclosure may be comprised of an aqueous blend of styrene-acrylic polymers having a glass transition temperature of +10° C. to +40° C.) and acrylate co-polymers (having a glass transition temperature of −25° C. to −55° C.) that may comprise 60-90 parts of the resultant composition. The film strength may be developed via an aqueous mixture of inert attapulgite and calcium carbonate (specifically meeting the requirements of the U.S. Pharmacopeia and Food Chemicals Codex monographs for calcium carbonate) that may comprise 10-30 parts of the resultant composition. In some embodiments of the present disclosure, it should be appreciated that minor additives may be included for coating rheology that may comprise 0-10 parts of the resultant composition. It should be appreciated that solids may comprise approximately 50-55% of the resultant composition. It also should be appreciated that the viscosity of peel away adhesive 103 may be in the range of approximately 14,000 to 25,000 cps. In some embodiments of the present disclosure, the viscosity may be in the range of approximately 16,200 to 22,000 cps.

Decal 102 may be formed with ink that may be transferred onto a user's body and may contain a design or decal according to embodiments of the present disclosure. It should be appreciated that the ink that may be used form decal 102 should be safe and non-toxic such that a user may apply to his/her body with minimal risk of adverse reaction.

It should be appreciated that decal 102 may include but is not limited to single colors, color combinations, sports logos or designs, costume masks, camouflage, patriotic designs, promotions for a company or cause, and combinations thereof. In additional embodiments of the present disclosure, decal 102 may be loaded with vitamins or other nutrients, as in an embodiment where decal 102 may be applied to a user's face in a dermatological treatment. Decal 102 also may be configured to provide sun protection, such as for athletes that play sports in the sun.

Protective laminate 104 may be applied to cover backing 101, decal 102, and adhesive 103 so that decal 102 may be protected until the user is ready to apply it to his/her body. It should be appreciated that other means may be used to protect decal 102 until ready for use without departing from the present disclosure.

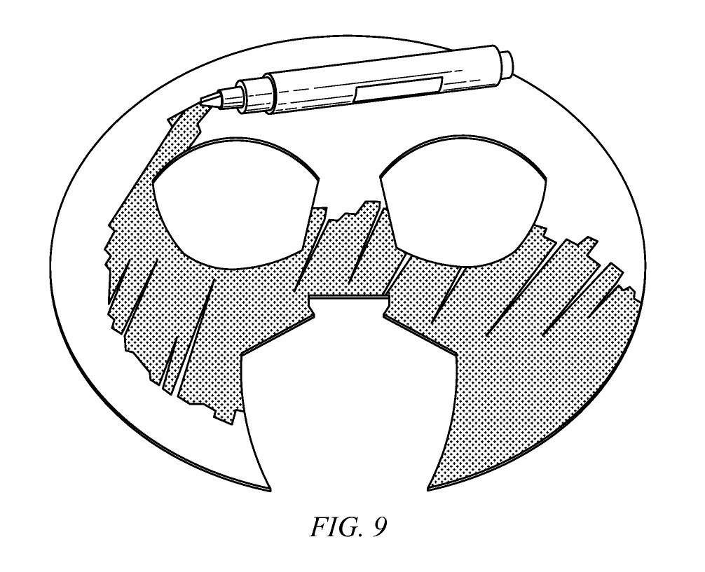

In an embodiment of the present disclosure, a dry apply temporary facial decal may be comprised of three layers: (1) a slip sheet; (2) an adhesive layer; and (3) a printable substrate. The slip sheet may be removed, and the decal may be applied directly to the user's face. The adhesive layer may have a similar formulation to that described with respect to FIG. 1. In addition, the slip sheet may similar to backing 101 described in FIG. 1. It should be appreciated that the printable substrate may assume a variety of forms, such as described with respect to decal 102. However, it also may be appreciated that the printable substrate may be provided in a solid color or be colorless (such as white) so that a user may design his/her own facial decal according to embodiments of the present disclosure, such as depicted in FIG. 9.

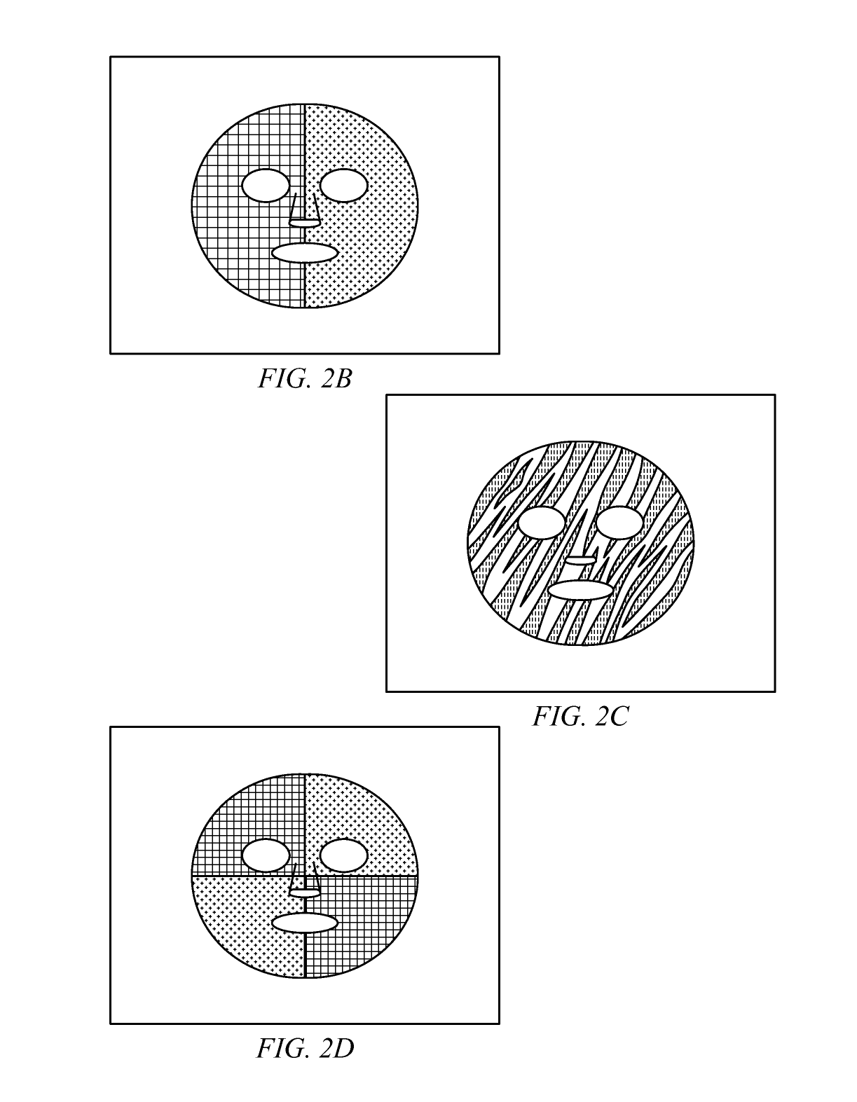

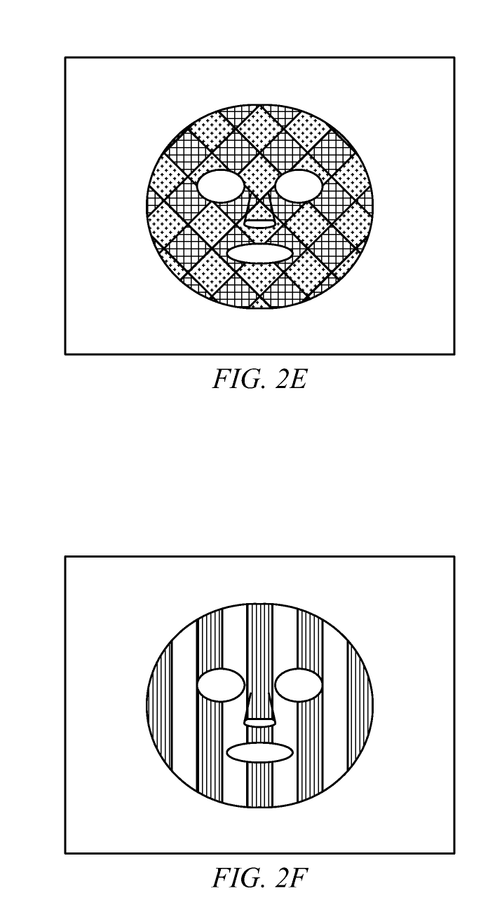

FIGS. 2-9 provide examples of dry apply and/or peel away temporary body decals according to embodiments of the present disclosure. While various categories of temporary body decals may be depicted through these Figures, it should be appreciated that other designs and colors may be utilized without departing from the present disclosure. Although full face designs may depicted in one or more of these Figures, it should be appreciated that the designs may be adapted to be applied to other parts of a user's body without departing from the present disclosure. It also should be appreciated that there may be embodiments wherein facial designs may not cover the user's entire face without departing from the present disclosure.

FIGS. 2A-2F depict color-related dry apply and/or peel away temporary body decals according to embodiments of the present disclosure. It should be appreciated that color-related temporary body decals may be provided in various forms including but not limited to splitfaces, tigerfaces, quadfaces, checkfaces and stripefaces with one or more colors or designs. More specifically, FIGS. 2A and 2B depict partial and full-face splitface dry apply and/or peel away temporary body decals according to embodiments of the present disclosure. FIG. 2C depicts a full-face tigerface dry apply and/or peel away temporary body decal according to an embodiment of the present disclosure. FIG. 2D depicts a full-face quadface dry apply and/or peel away temporary body decal according to an embodiment of the present disclosure. FIG. 2E depicts a full-face checkface dry apply and/or peel away temporary body decal according to an embodiment of the present disclosure. FIG. 2F depicts a full-face stripeface dry apply and/or peel away temporary body decal according to an embodiment of the present disclosure. While some decals have been depicted a full-face decals, it should be appreciated that the decals may be provided to partially cover the face or another part of the body without departing from the present disclosure. It also should be appreciated that color-related temporary body decals also may be specific to a team, a team's colors, a theme, and/or a particular sport without departing from the present disclosure.

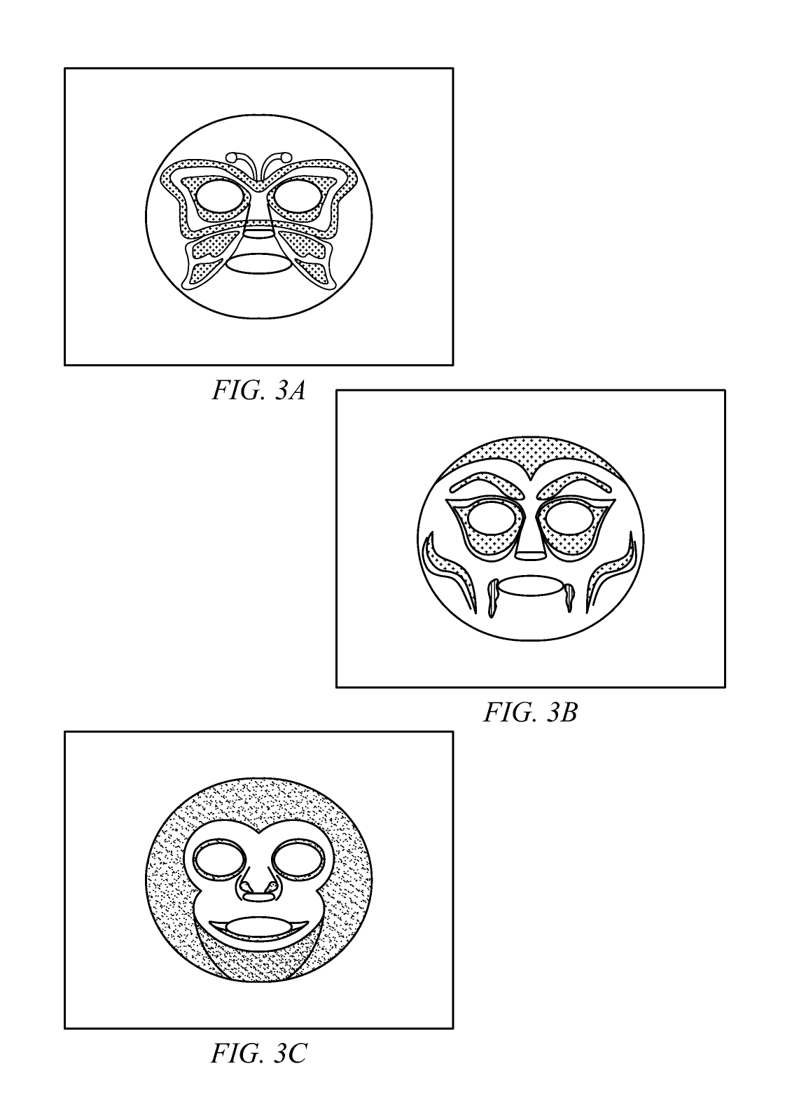

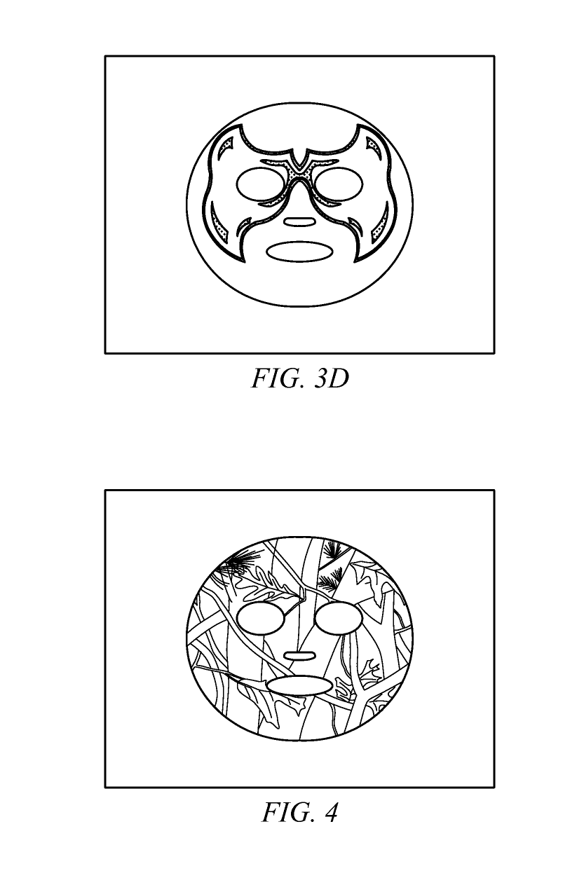

FIGS. 3A-3D depict costume-related dry apply and/or peel away temporary body decals according to embodiments of the present disclosure. More specifically, FIG. 3A depicts a butterfly temporary body decal, FIG. 3B depicts a Dracula-themed temporary body decal, FIG. 3C depicts an animal-themed temporary body decal, and FIG. 3D depicts a mask-type temporary body decal. In some embodiments of the present disclosure, these temporary body decals may be used as part of Halloween costumes or for other events, such as Mardi Gras, and may be used to cover all or a portion of a user's face. In other embodiments of the present disclosure, these temporary body decals may be used to cover or adorn other portions of a user's body to complement a costume.

FIG. 4 depicts a camouflage dry apply and/or peel away temporary body decal according to embodiments of the present disclosure. While a particular camouflage pattern is depicted in FIG. 4, it should be appreciated that other camouflage patterns may be utilized without departing from the present disclosure.

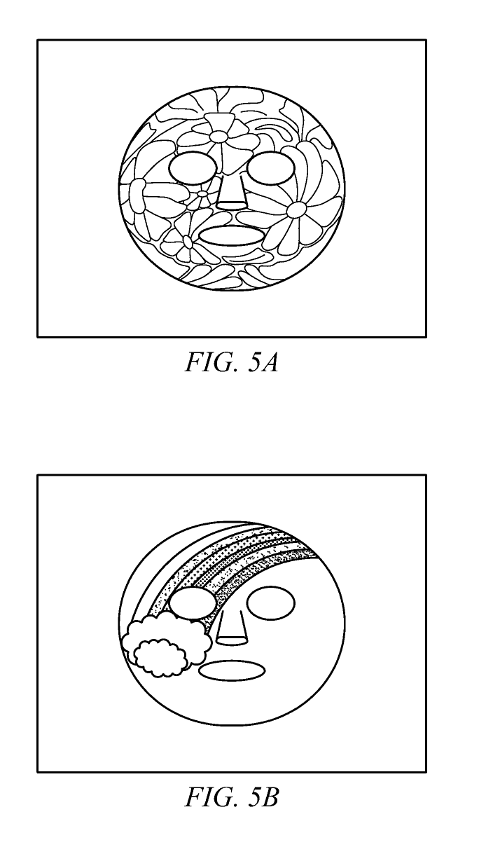

FIGS. 5A-5B depict girl-focused dry apply and/or peel away temporary body decals according to embodiments of the present disclosure. More specifically, FIG. 5A depicts a flower-themed temporary body decal and FIG. 5B depicts a rainbow-themed temporary body decal. However, it should be appreciated that other patterns and styles may be included on temporary body decals without departing from the present disclosure. While these temporary body decals may be depicted to cover all or a portion of a user's face, it should be appreciated that other embodiments of the present disclosure may provide temporary body decals that may be applied to other portions of a user's body without departing from the present disclosure.

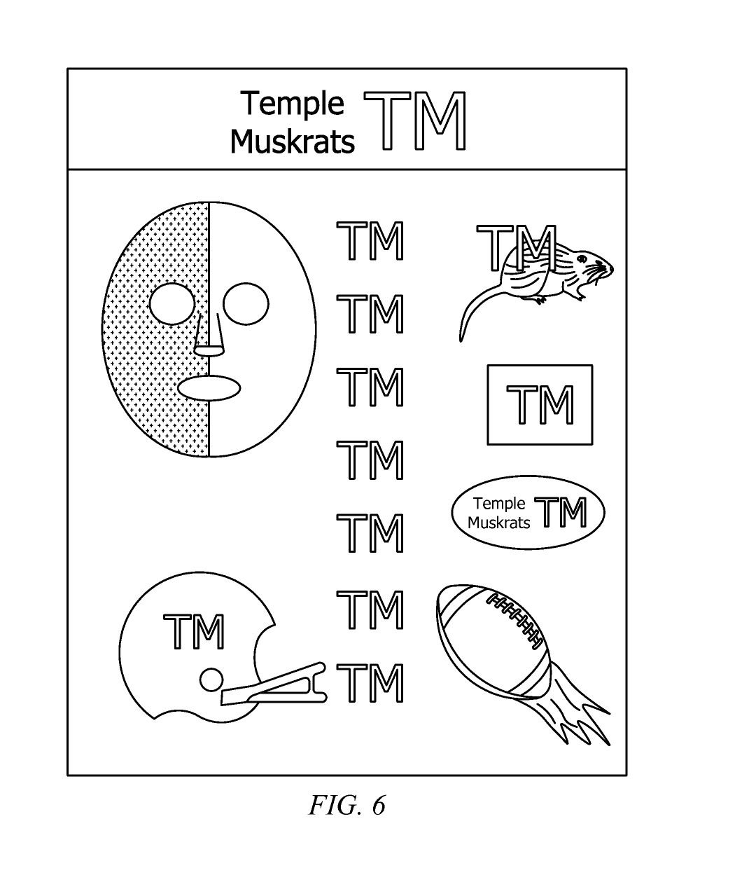

FIG. 6 depicts a tear and share dry apply and/or peel away temporary body decal according to an embodiment of the present disclosure. As depicted, a single backing may provide several temporary body decals of complementary colors. However, as will be discussed, tear and share temporary body decals may include the same design repeated multiple times on a single backing or different designs without departing from the present disclosure.

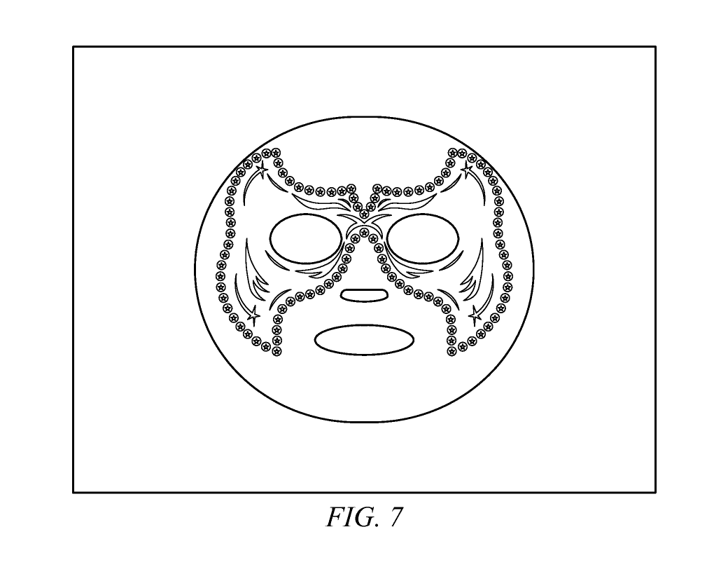

FIG. 7 depicts a party-related dry apply and/or peel away temporary body decal according to an embodiment of the present disclosure. As depicted in FIG. 7, it should be appreciated that colors as well as other decorative materials, such as glitter and jewels, may be incorporated into the decal/design without departing from the present disclosure. In other embodiments of the present disclosure, it should be appreciated that the decal/design also may include components such that it may glow in the dark.

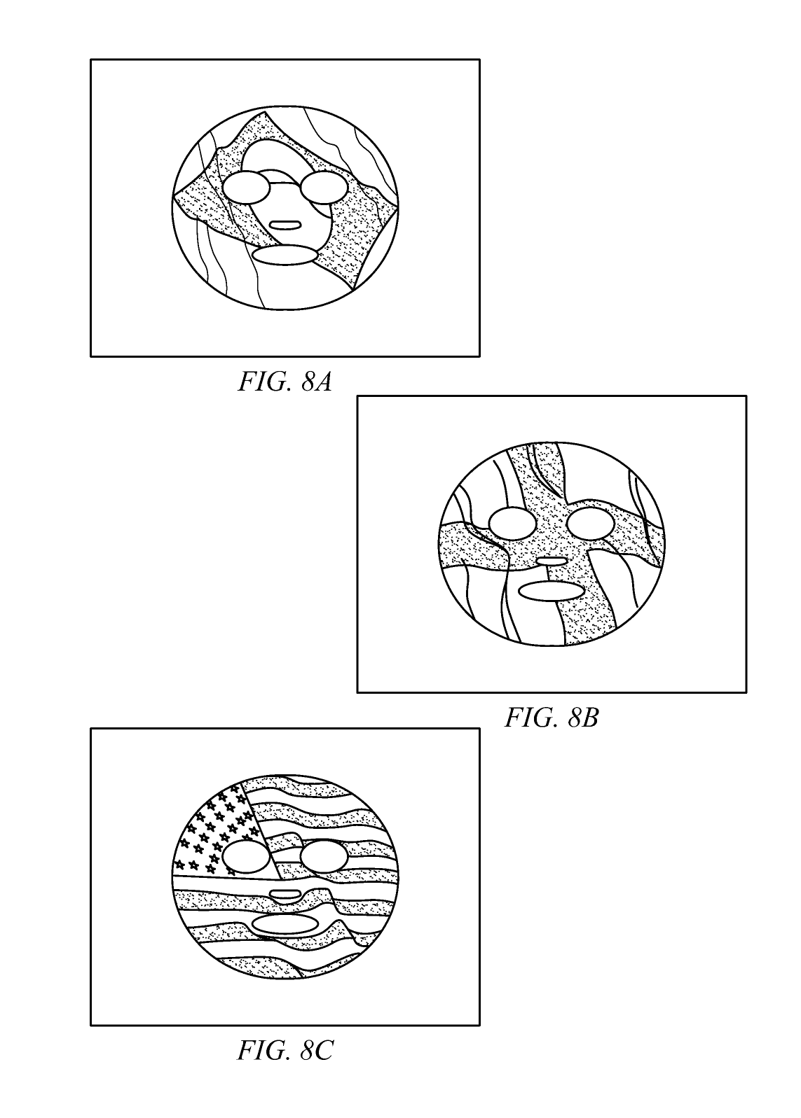

FIGS. 8A-8C depict flag-related dry apply and/or peel away temporary body decals according to embodiments of the present disclosure. Although several flags or flag-related colors, such as associated with Brazil, England and the United States, may be depicted in FIGS. 8A-8C, it should be appreciated that other flags and flag-related colors may be incorporated into dry apply and/or peel away temporary body decals without departing from the present disclosure. Further, while the temporary body decals in FIGS. 8A-8C are depicted as full face applications, it should be appreciated that temporary body decals incorporating a flag pattern may be provided for application on other portions of a user's body without departing from the present disclosure.

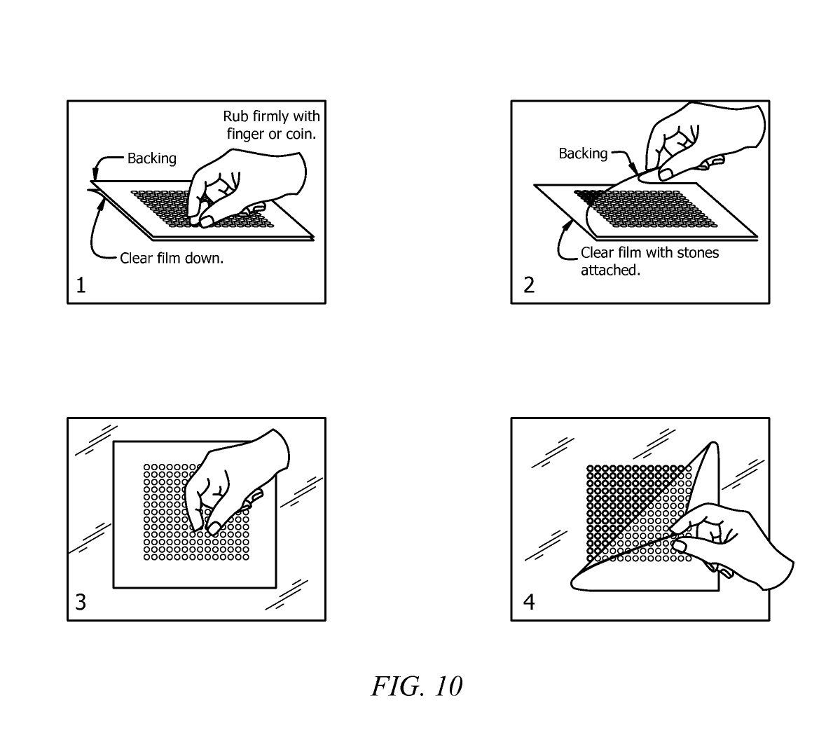

In some embodiments of the present disclosure, a dry apply and/or peel away temporary body decal may apply jewels or a jewel-type design to a user's face. FIG. 10 depicts a method for apply a jewel-type dry apply and/or peel away temporary body decal according to an embodiment of the present disclosure. A jewel-type dry apply and/or peel away temporary body decal may have a backing attached to the decal. In a first step, before the backing is removed from the decal, the decal may be placed down on a surface. A user may use his/her fingernail or another scratching mechanism, such as a coin, to carefully but firmly rub all of the jewels or jewel-type structures to seat them onto a front clear film. In a second step, the user may then slowly peel back the backing attached to the decal leaving the jewels or jewel-type structures adhered to the clear film. It should be appreciated that if a jewel or a jewel-type structure remains affixed to the backing, the user may press the jewel or jewel-type structure back down using his/her finger. Each of the jewels or jewel-type structures should be adhered to the clear film. In a third step, the user may place (or have placed) the clear film against his/her face or another part of the user's body. It should be appreciated that the clear film should be placed in position where the user wishes to transfer the jewels or jewel-type structures, and the jewels or jewel-type structures should be applied directly to the face or other body part. Each jewel or jewel-type structure should be pressed using a fingernail or another item applying pressure to the user's face or other part of the body to ensure a good bond. In a fourth step, the clear film may be peeled away slowly. If jewels or jewel-type structures stick to the clear film as it is being removed, the clear film may be pressed to the user's face or other body part again to complete transfer of the jewels or jewel-type structures according to an embodiment of the present disclosure. While FIG. 10 has been described as utilizing a clear film, it should be appreciated that the film may be colored without departing from the present disclosure. Further, the backing utilized for a jewel or jewel-type temporary body decal may be formed of plastic or another similar material without departing from the present disclosure. It also should be appreciated that the backing may include an additional covering layer without departing from the present disclosure.

In some embodiments of the present disclosure, a dry apply and/or peel away temporary body decal that may be applied to a user's face may include eye holes as well as an opening around the chin and/or mouth area. Eyeholes should at least be large enough so that a user may be able to see through the eyeholes; however, there may be other embodiments of the present disclosure wherein the eyeholes may be enlarged without departing from the present disclosure. Similarly, the opening around the chin and/or mouth area should at least be large enough so that a user may move his/her mouth and talk; however, there may be other embodiments of the present disclosure wherein the opening may be enlarged so that a user may scream and yell, such as when he/she wears the temporary body decal during a sporting event, without departing from the present disclosure.

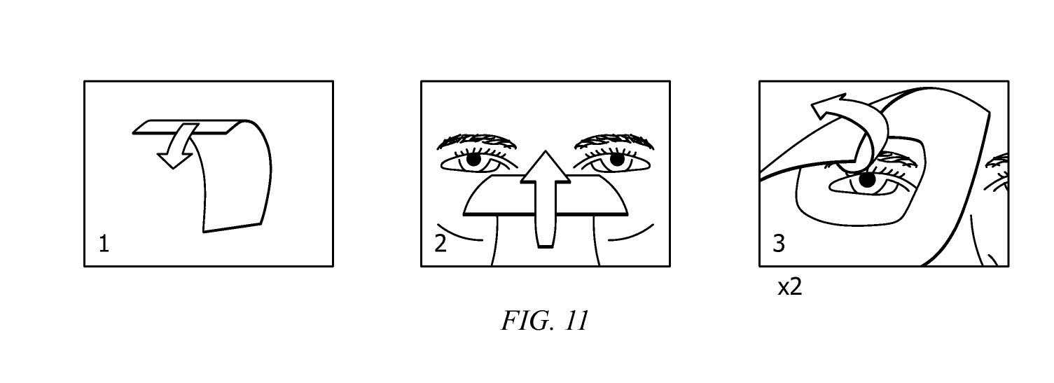

FIG. 11 depicts a method to apply a dry apply and/or peel away temporary body decal according to an embodiment of the present disclosure. In this embodiment of the present disclosure, a temporary body decal may be applied to a user's face. In a first step, the backing associated with the temporary body decal may be peeled away. In a second step, the temporary body decal may be centered on the user's nose with the adhesive side facing the user's skin and then the body decal may be pressed onto the user's face with the eye holes in the area of the user's eyes in a third step. It should be appreciated that the body decal should be pressed onto the user's face from the nose outward and loose areas of the body decal should be secured according to embodiments of the present disclosure. In some embodiments of the present disclosure, if the user has facial hair, the body decal may be trimmed to fit around the facial hair. It also should be appreciated that before the temporary body decal is applied to the user's body, the area where the body decal is to be applied should be washed and thoroughly dried so that it may be free of oils and makeup that may reduce the adherence properties of the body decal, according to embodiments of the present disclosure. When the temporary body decal is to be removed, the user should find a loose edge of the decal, then lift that edge, stretch the decal and then it should be peeled off the user's body.

It should be appreciated that dry apply and/or peel away temporary body decals according to embodiments of the present disclosure may be applied to a user's face or to other regions of the user's body as desired. It also should be appreciated that dry apply and/or peel away temporary body decals may be provided for a single application or for multiple applications without departing from the present disclosure. In some embodiments of the present disclosure, dry apply and/or peel away temporary body decals may be provided wherein a single body decal is included on the backing or slip sheet. However, in other embodiments of the present disclosure, more than one dry apply and/or peel away temporary body decal may be provided on a single backing or slip sheet. It also should be appreciated that if more than one body decal is provided on a single backing or slip sheet, the body decals may each take the same form (i.e., may be the same design/decal), but in other embodiments, various different body decals may be provided on a single backing or slip sheet. Regardless, when there is more than one body decal on a single backing or slip sheet, a user may select a dry apply and/or peel away temporary body decal to apply and then may save the others for later use or share with other potential users by selectively cutting or tearing off body decals as needed.

It should be appreciated that dry apply and/or peel away temporary body decals according to embodiments of the present disclosure may be provided in a single size that may be trimmed to fit an area where the user wishes to apply the temporary body decal. For example, a dry apply and/or peel away temporary body decal may take the form of a full-face temporary body decal. As users' faces may differ in size and shape, a user may adjust the size of the temporary body decal so that it may better conform to his/her face. This adjustment may be done through use of scissors or other cutting mechanisms according to embodiments of the present disclosure. In other embodiments of the present disclosure, dry apply and/or peel away temporary body decals may be provided in different sizes to fit different users or different areas of the body.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for applying a temporary body decal to a user's face, the method comprising:
peeling away a backing associated with the temporary body decal, the temporary body decal including a decal, an adhesive on one side of the decal, and the backing;
centering the temporary body decal on the user's nose with the adhesive of the temporary body decal facing the user's skin; and
pressing the temporary body decal onto the user's face with eyeholes of the temporary body decal in the area of the user's eyes.

2. The method of claim 1, wherein the pressing step further comprises:
pressing onto the user's face from the nose portion outward; and
securing loose areas of the temporary body decal.

3. The method of claim 1 wherein before the temporary body decal is centered on the user's name, the area of the user's face where the temporary body decal is to be applied is washed and dried.

4. The method of claim 1 further comprising:
removing the temporary body decal by the following steps:
identifying a loose edge of the temporary body decal;
lifting the loose edge of the temporary body decal;
stretching the temporary body decal; and
peeling the temporary body decal from the user's face.

5. The method of claim 4 wherein the removing step is performed without the use of a wetting mechanism.

6. The method of claim 1 wherein the centering and pressing steps are performed without the use of a wetting mechanism.

7. The method of claim 1 wherein the decal is selected from the group comprising:
single colors, color combinations, sports logos or designs, costume masks, camouflage, patriotic designs, paint-your-own, promotions for a company or cause, and combinations thereof.

8. A dry apply temporary body decal comprising:
a decal;
an adhesive applied to the decal that transfers the decal to a user's body; and
a backing that is releasably detachable from the decal,
wherein the decal is transferred to a user's body without the use of a wetting mechanism.

9. The dry apply temporary body decal of claim 8 wherein the backing is a single piece of material.

10. The dry apply temporary body decal of claim 8 wherein the backing is formed as more than one piece of material.

11. The dry apply temporary body decal of claim 8 wherein the adhesive enables removal of the decal from the user's body.

12. The dry apply temporary body decal of claim 8, the adhesive comprising:
an aqueous blend of styrene-acrylic polymers having a glass transition temperature of +10° C. to +40° C. and acrylate co-polymers having a glass transition temperature of −25° C. to −55° C. comprising 60-90 parts of the adhesive; and
an aqueous mixture of inert attapulgite and calcium carbonate comprising 10-30 parts of the adhesive.

13. The dry apply temporary body decal of claim 12, the adhesive further comprising:
additives for coating rheology comprising 10 parts or less of the adhesive.

14. The dry apply temporary body decal of claim 8, wherein the decal is selected from the group comprising:
single colors, color combinations, sports logos or designs, costume masks, camouflage, patriotic designs, paint-your-own, promotions for a company or cause, and combinations thereof.

15. The dry apply temporary body decal of claim 8 wherein the decal is removed from the user's body without use of a wetting mechanism.

16. A peel away temporary body decal comprising:
a decal;
an adhesive applied to the decal that transfers the decal to a user's body and enables removal of the decal from the user's body; and
a backing that is releasably detachable from the decal,
wherein removal of the decal occurs without use of a wetting mechanism.

17. The peel away temporary body decal of claim 16 wherein the adhesive has a viscosity in the range of approximately 14,000 to 25,000 cps.

18. The peel away temporary body decal of claim 16 wherein the adhesive has a viscosity in the range of approximately 16,200 to 22,000 cps.

19. The peel away temporary body decal of claim 16, wherein the decal is selected from the group comprising:
single colors, color combinations, sports logos or designs, costume masks, camouflage, patriotic designs, paint-your-own, promotions for a company or cause, and combinations thereof.

20. The peel away temporary body decal of claim 16 wherein the decal is transferred to a user's body without use of a wetting mechanism.
